(19) United States
(12) Patent Application Publication
(10) Pub. No.: US 2026/0135174 A1
(43) Pub. Date: May 14, 2026

(54) GARDEN BATTERY PACK

(71) Applicant: Xiangfen LI, Heihe (CN)

(72) Inventor: Xiangfen LI, Heihe (CN)

(21) Appl. No.: 19/443,064

(22) Filed: Jan. 8, 2026

(51) Int. Cl. H01M 10/48; H01M 10/42; H01M 50/247; H01M 50/284; H01M 50/296

(52) U.S. Cl. CPC H01M 10/488; H01M 10/4257; H01M 10/482; H01M 50/247; H01M 50/284; H01M 50/296; H01M 2010/4271

(57) ABSTRACT

A garden battery pack is provided, including: an outer housing for accommodating battery cells; a control assembly electrically connected to the battery cells within the outer housing, wherein the control assembly being configured to distribute and manage electrical energy from the battery cells; the control assembly is equipped with a light-emitting component that illuminates when the control assembly allocates electrical energy from the battery cells to the light-emitting component; a display device is mounted on the control assembly; a button module is mounted on the control assembly; the outer housing is provided with a plurality of slots; the outer housing is provided with a power interface, and the control assembly is equipped with an interface assembly that can be adaptively mounted at the power interface; the interface assembly facilitates power distribution between external devices and the battery cell via the power cable.

### FIELD

The present disclosure relates to the technical field of garden tools, specifically to a garden battery pack.

### BACKGROUND

With the widespread adoption of new energy storage products like lithium batteries, garden tools have gradually shed their dependence on fixed power sources, achieving a significant shift toward portability and wireless operation. Common tools on the market today—such as lawn mowers, chainsaws, hedge trimmers, and garden blowers—largely feature rechargeable designs, enabling users to work flexibly and conveniently across various outdoor settings.

However, incorporating batteries with excessively large capacities into garden tools significantly increases their bulk and weight, making them cumbersome and difficult to carry. Consequently, many users opt to carry separate battery packs as portable power sources for quick recharging when tool batteries run low.

Despite this, existing battery packs still face certain limitations in functional design. On one hand, landscaping tasks often occur in poorly lit environments like corners, yet most battery packs on the market lack integrated lighting, making operation difficult in dim conditions. On the other hand, battery packs frequently lack clear, intuitive power displays and user interfaces, making it hard for users to monitor remaining charge in real time. This hinders effective management of the charging and discharging process, causing significant inconvenience during actual use.

### SUMMARY

The present disclosure provides a garden battery pack to overcome the limitations of current models.

According to some embodiments of the present disclosure, a garden battery pack is provided, including: an outer housing for accommodating battery cells; a control assembly electrically connected to the battery cells within the outer housing, wherein the control assembly being configured to distribute and manage electrical energy from the battery cells; the control assembly is equipped with a light-emitting component that illuminates when the control assembly allocates electrical energy from the battery cells to the light-emitting component; a display device is mounted on the control assembly, displaying information based on electrical signals from the control assembly; a button module is mounted on the control assembly, transmitting electrical signals to the control assembly when pressed; the outer housing is provided with a plurality of slots, allowing light from the light-emitting component to be emitted through the slots and enabling information from the display device to be observed externally through the slots of the outer housing; the outer housing is provided with a power interface, and the control assembly is equipped with an interface assembly that can be adaptively mounted at the power interface; the interface assembly facilitates power distribution between external devices and the battery cell via the power cable when the power cable is connected to the power interface.

In some embodiments, the outer housing comprises a main housing and a base housing interlocked together, with a containment chamber formed between the main housing and the base housing, and the control assembly is mounted within the containment chamber; the outer housing features an operating surface and a functional surface, and the power interface is provided on the operating surface, while the slots are provided on the functional surface.

In some embodiments, the control assembly comprises a main control board and a sub-control board electrically connected to each other, the main control board being disposed on the inner side of the operating surface, and the interface assembly being mounted on the main control board; the sub-control board is mounted on the inner side of the functional surface, and the light-emitting component, the button module, and the display device are all mounted on the sub-control board.

In some embodiments, the slots comprise a display slot and an illumination slot, the display device is adaptable for installation in the display slot, and the light-emitting component is adaptable for installation in the illumination slot.

In some embodiments, a display light-transmitting component is installed at the display slot to seal the display slot and allow light from the display device to pass through.

In some embodiments, the illumination slot is fitted with an illumination light-transmitting component to enclose the illumination slot while allowing light from the light-emitting component to pass through.

In some embodiments, the outer housing is provided with an elastic pressure plate corresponding to the button module, and pressing the elastic pressure plate can trigger the button module.

In some embodiments, the outer housing is mounted with a button plate, the button plate is provided with a raised section corresponding to the elastic pressure plate, and pressing the raised section can depress the elastic pressure plate.

In some embodiments, the outer housing includes a battery cell holder installed therein, and the battery cells are configured as a plurality mounted on the battery cell holder, with the plurality of battery cells electrically connected to form a cell module.

In some embodiments, the output voltage of the cell module is 20V.

### BRIEF DESCRIPTION OF THE DRAWINGS

The accompanying drawings are provided to facilitate further understanding of the present disclosure and form part of the present disclosure. The illustrative embodiments and their descriptions are intended to explain the present disclosure and do not constitute undue limitations thereof. In the drawings:

FIG. 1 is a schematic diagram of the overall structure of the garden battery pack according to some embodiments, first perspective.

FIG. 2 is a schematic diagram of the overall structure of the garden battery pack according to some embodiments, second perspective.

FIG. 3 is an exploded view of the garden battery pack according to some embodiments, illustrating the internal structure of the containment chamber.

FIG. 4 is a sectional view of the garden battery pack according to some embodiments, illustrating the internal structure of the containment chamber.

### DETAILED DESCRIPTION

To further illustrate the content, features, and efficacy of the present disclosure, the following embodiments are provided and described in detail with reference to the accompanying drawings:

### Embodiment 1

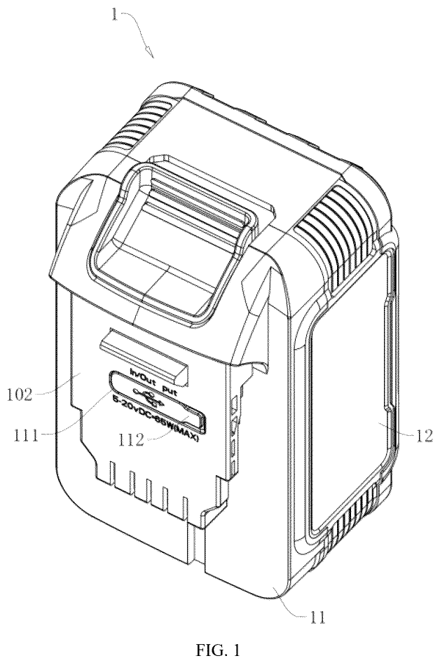

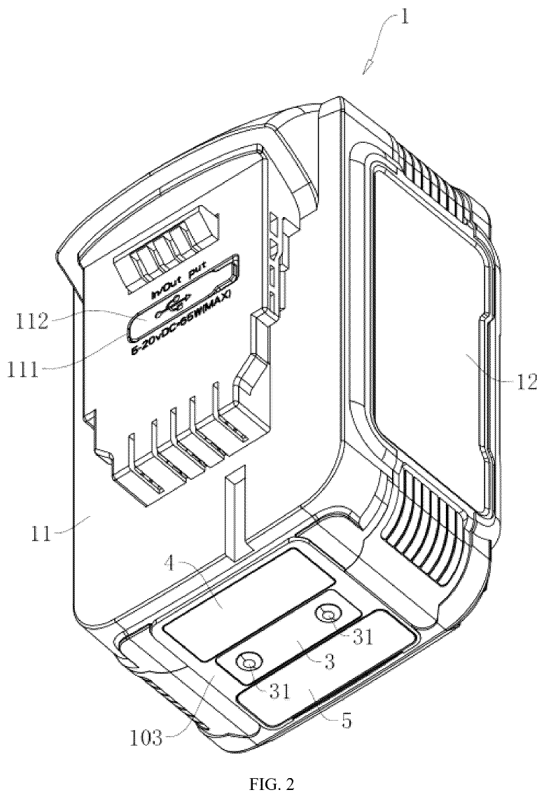

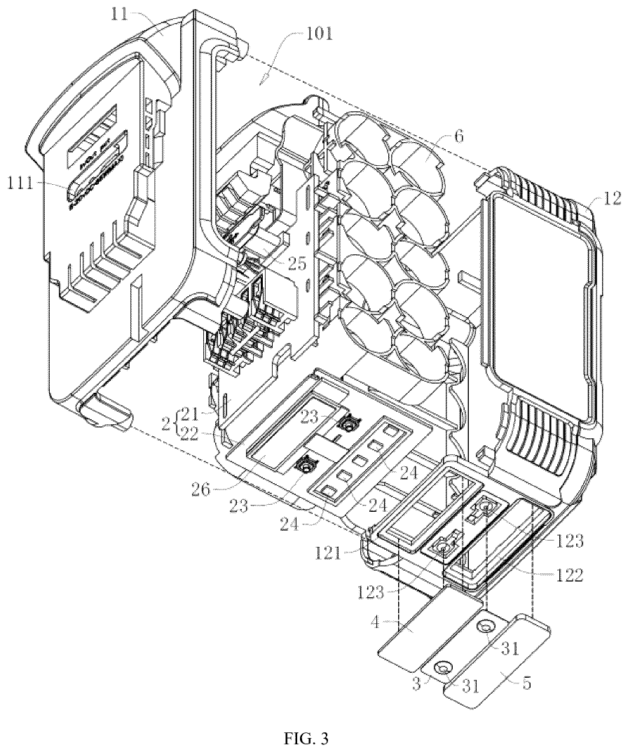

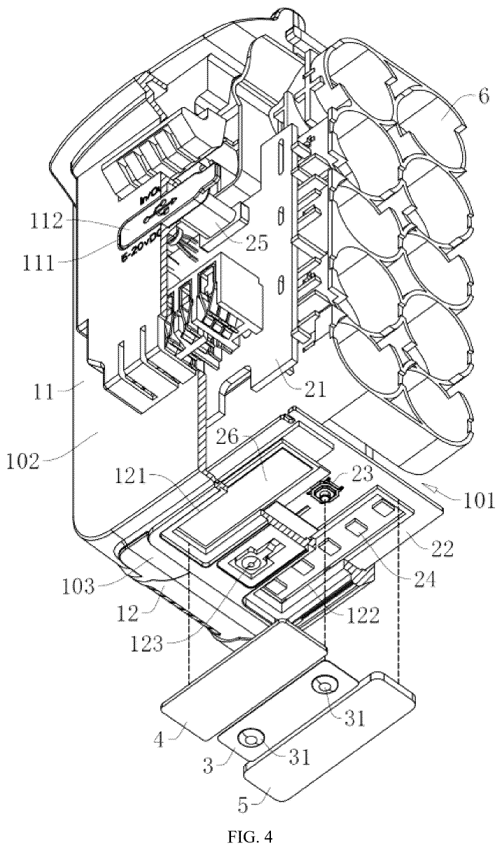

Please refer to FIG. 1-4, this embodiment discloses a garden battery pack for powering garden tools, including an outer housing 1 for accommodating battery cells. The outer housing 1 further includes a main housing 11 and a base housing 12 that interlock with each other. A containment chamber 101 for installing components is formed between the main housing 11 and the base housing 12. A battery cell holder 6 is provided within the containment chamber 101 to provide mounting positions for the battery cells. Correspondingly, the battery cell holder 6 holds multiple cells (not shown) electrically interconnected to store electrical energy. In this embodiment, cylindrical cells are employed, and the cell module formed by these multiple cells delivers an output voltage of 20V.

Specifically, the outer housing 1 adopts a rectangular prism structure, featuring an operating surface 102 and a functional surface 103 on its exterior. The operating surface 102 is located on the main housing 11, The operating surface 102 provides at least one power interface 111 for connecting to a power cord to enable charging or discharging. The functional surface 103 is positioned on the base housing 12, adjacent to the connection point with the main housing 11, to provide mounting space for user interaction devices. In this embodiment, only one aforementioned power interface 111 is provided on the operating surface 102. An interface cover 112 is installed over this power interface 111. The interface cover 112 is mounted in an openable manner over the power interface 111 to protect its internal structure. The interface cover 112 is made of elastic material to facilitate opening and closing by the user.

The containment chamber 101 contains a control assembly 2 for managing battery cell charging or power distribution. The control assembly 2 further includes a main control board 21 and a sub-control board 22. Both the main control board 21 and sub-control board 22 are PCB boards electrically interconnected to transmit power or exchange electrical signals. The main control board 21 is positioned on the inner side of the operating surface 102, with one side facing the operating surface 102. An interface assembly 25 is mounted on the side of the main control board 21 facing the operating surface 102. This interface assembly 25 is adaptively installed at the power interface 111. After the user opens the interface cover 112, the power cord can be electrically connected to the interface assembly 25 at the power interface 111, thereby enabling power transmission. The battery cells on the battery cell holder 6 are electrically connected to the main control board 21 and/or the sub-control board 22. The main control board 21 and/or the sub-control board 22 integrate circuits for managing the electrical energy within the battery cells. These circuits can regulate the electrical energy of the battery cells based on the connection status of the power interface 111 and the electrical signals received by the main control board 21 and/or the sub-control board 22.

The sub-control board 22 is mounted on the inner side of the functional surface 103, with one side facing the functional surface 103. A button module 23 is mounted on this side of the sub-control board 22, facing the functional surface 103. The button module 23 interacts with the user, generating an electrical signal when pressed. This interactive electrical signal is transmitted to the control circuit within the sub-control board 22 to command relevant components to execute corresponding actions. The sub-control board 22 also houses a display device 26, which is a display assembly for presenting battery status information and interaction data. In this embodiment, the display device 26 is an LCD screen assembly. It is electrically connected to the sub-control board 22 and displays information based on control signals from the board, providing users with battery status updates and interaction control details. Additionally, multiple light-emitting components 24 are mounted on the sub-control board 22. In this embodiment, the light-emitting components 24 are LED modules. The sub-control board 22 can selectively distribute power from the battery cells to the light-emitting components 24 based on circuit logic or electrical signals, causing the light-emitting components 24 to illuminate or turn off.

To provide mounting space for the display device 26 and enable users to view its information, a display slot 121 is formed on the functional surface 103 of the base housing 12. The display slot 121 is a long, elongated slot. The shape and dimensions of the display device 26 match those of the display slot 121. The display device 26 is adaptively mounted within this display slot 121. The display device 26 displays corresponding information based on electrical signals from the main control board 21 and the sub-control board 22. Users can observe the information displayed on the display device 26 through the display slot 121. Additionally, a display light-transmitting component 4 is installed at the display slot 121. The display light-transmitting component 4 is made of light-transmitting material, with its shape and dimensions matching those of the display slot 121. It covers the outer side of the display device 26, with its edges fixed to the edges of the display slot 121. The display light-transmitting component 4 protects the display device 26, reducing the probability and severity of damage to the display device 26.

Similarly, to provide mounting space for the aforementioned light-emitting components 24 and enable their light to illuminate the exterior of the outer housing 1, an illumination slot 122 is also formed on the functional surface 103 of the base housing 12. The illumination slot 122 is an elongated slot arranged parallel to the display slot 121. Each of the multiple light-emitting components 24 corresponds to the illumination slot 122, with the light-emitting components 24 directed outward toward the illumination slot 122. When the sub-control board 22 distributes electrical energy from the battery cell to the light-emitting components 24, the light-emitting components 24 illuminate, providing lighting for gardeners to facilitate work in poorly lit environments. An illumination light-transmitting component 5 is installed at the illumination slot 122. The illumination light-transmitting component 5 is made of a light-transmitting material, allowing light from the light-emitting components 24 to pass through and be emitted. The shape and dimensions of the illumination light-transmitting component 5 match those of the illumination slot 122. It covers the outer side of the light-emitting component 24, with its edges secured to the edges of the illumination slot 122. The illumination light-transmitting component 5 protects the light-emitting component 24, reducing the probability and severity of damage to the light-emitting component 24.

The functional surface 103 of the base housing 12 is equipped with an elastic pressure plate 123. The elastic pressure plate 123 is formed by a hollow-out process on the surface of the functional surface 103 and possesses a certain press stroke within its own elastic limit. In this embodiment, two elastic pressure plates 123 are provided, and two corresponding button modules 23 are also provided. Each elastic pressure plate 123 corresponds to one button module 23. Pressing the elastic pressure plate 123 triggers the button module 23, causing it to generate an electrical signal that is then transmitted to the circuitry within the sub-control board 22. Both elastic pressure plates 123 are positioned between the display slot 121 and the illumination slot 122. All elastic pressure plates 123 are fully covered by a button plate 3. The button plate 3 features a long, strip-like structure and is fixed to the functional surface 103. Its surface incorporates raised section 31 capable of elastic deformation. Each raised section 31 corresponds to an elastic pressure plate 123. This button plate 3 seals the gaps at the elastic pressure plates 123, enhancing user tactile feedback and experience while improving the visual integrity of the product's overall structure.

The operating principle and beneficial effects of the present disclosure are as follows: On one hand, by installing a control circuit board inside the outer housing 1 and mounting a light-emitting component 24 on the control circuit board, the control circuit board can distribute electrical energy from the battery cell to the light-emitting component 24 as needed to activate its illumination. This enables users to utilize the product for lighting in poorly illuminated environments, thereby resolving the inconvenience of operating garden battery packs in dimly lit conditions. On the other hand, by incorporating a display device 26 and a button module 23, users can obtain device information such as battery charge levels via the display device 26 and interact with the device through the button module 23. This enables effective management of processes like battery cell charging and discharging, resolving the issues of inconvenient power level display and limited human-machine interaction in existing garden battery packs.

The above are merely embodiments of the present disclosure and are not intended to limit the scope of the present disclosure. For those skilled in the art, the present disclosure may be subject to various modifications and variations. Any modifications, equivalent substitutions, improvements, etc., made within the spirit and principles of the present disclosure shall be included within the scope of the appended claims.

1. A garden battery pack comprising: an outer housing for accommodating battery cells; a control assembly electrically connected to the battery cells within the outer housing, wherein the control assembly being configured to distribute and manage electrical energy from the battery cells;
the control assembly is equipped with a light-emitting component that illuminates when the control assembly allocates electrical energy from the battery cells to the light-emitting component; a display device is mounted on the control assembly, displaying information based on electrical signals from the control assembly; a button module is mounted on the control assembly, transmitting electrical signals to the control assembly when pressed;
the outer housing is provided with a plurality of slots, allowing light from the light-emitting component to be emitted through the slots and enabling information from the display device to be observed externally through the slots of the outer housing;
the outer housing is provided with a power interface, and the control assembly is equipped with an interface assembly that can be adaptively mounted at the power interface; the interface assembly facilitates power distribution between external devices and the battery cell via the power cable when the power cable is connected to the power interface.

2. The garden battery pack according to claim 1, wherein the outer housing comprises a main housing and a base housing interlocked together, with a containment chamber formed between the main housing and the base housing, and the control assembly is mounted within the containment chamber;
the outer housing features an operating surface and a functional surface, and the power interface is provided on the operating surface, while the slots are provided on the functional surface.

3. The garden battery pack according to claim 2, wherein the control assembly comprises a main control board and a sub-control board electrically connected to each other, the main control board being disposed on the inner side of the operating surface, and the interface assembly being mounted on the main control board; the sub-control board is mounted on the inner side of the functional surface, and the light-emitting component, the button module, and the display device are all mounted on the sub-control board.

4. The garden battery pack according to claim 1, wherein the slots comprise a display slot and an illumination slot, the display device is adaptable for installation in the display slot, and the light-emitting component is adaptable for installation in the illumination slot.

5. The garden battery pack according to claim 4, wherein a display light-transmitting component is installed at the display slot to seal the display slot and allow light from the display device to pass through.

6. The garden battery pack according to claim 4, wherein the illumination slot is fitted with an illumination light-transmitting component to enclose the illumination slot while allowing light from the light-emitting component to pass through.

7. The garden battery pack according to claim 1, wherein the outer housing is provided with an elastic pressure plate corresponding to the button module, and pressing the elastic pressure plate can trigger the button module.

8. The garden battery pack according to claim 7, wherein the outer housing is mounted with a button plate, the button plate is provided with a raised section corresponding to the elastic pressure plate, and pressing the raised section can depress the elastic pressure plate.

9. The garden battery pack according to claim 1, wherein the outer housing includes a battery cell holder installed therein, and the battery cells are configured as a plurality mounted on the battery cell holder, with the plurality of battery cells electrically connected to form a cell module.

10. The garden battery pack according to claim 9, wherein the output voltage of the cell module is 20V.
